(19) United States
(12) Patent Application Publication
(10) Pub. No.: US 2006/0080540 A1
(43) Pub. Date: Apr. 13, 2006

(54) Removable/detachable operating system

(76) Inventors: Robert Arnon, Corpus Christi, TX (US); Richard Dellacona, Riverside, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/962,026

(22) Filed: Oct. 8, 2004

(51) Int. Cl. H04L 9/00

(52) U.S. Cl. 713/182

(57) ABSTRACT

An OS module is plug compatible with a host computer preferably through its USB port. The module includes a data signal gate, a hardwire write control device, a first memory device, and a second memory device. The first memory device holds portions of an OS that are unchanged during startup and operation of the host computer, while the second memory device holds portions of the OS that may be changed during startup and operation of the host computer. These components are interconnected for data signal flow between the host computer and the second memory device through the data signal gate, while data signal flow from the computer for writing to the first memory device is functional only through the data signal gate and the write control device. The first memory device may be read without limitation.

### RELATED APPLICATIONS

none

### BACKGROUND OF THE INVENTION

1. Field of the Invention

This invention relates generally to computer systems and more particularly to a computer system with a removable or detachable operating system or an operating system that may be locked or write protected.

2. Description of Related Art

The following art defines the present state of this field and each disclosure is hereby incorporated herein by reference:

Adcock, U.S. Pat. No. 5,835,894, and U.S. Pat. No. 6,161,094, describe a security method that compares a present verbal utterance with a previously recorded verbal utterance by comparing frequency domain representations of the utterances, with multiple repeat utterances forming a basis for determining a variation in repetitious performance by an individual, and similar differences between enrollment and challenge utterances forming a basis for a similar analysis of variance between enrollment and challenge utterances. In one embodiment a set of enrollment data is searched by each challenge until either a match is made, indicating an action, possibly dependent upon the specific match, or no match is made indicating an abort.

Thomas et al., U.S. Pat. No. 6,016,402, describes a large capacity removable media drive that is integrated into a computer as a floppy disk drive. The method and apparatus are suited to an environment in which the removable media disk drive is configured as the first fixed disk drive in the computer. Thus, the removable media drive is recognized by the BIOS as a fixed disk drive. A substitute master boot record is provided to the computer from the removable media drive in response to a request for the master boot record of the media. Control of the boot sequence is thereby gained. The substitute master boot record loads a boot program that alters the operating system to recognize the removable media drive as a floppy disk drive.

Sallam, U.S. Pat. No. 6,421,232, describes an invention that is essentially a flat panel display, preferably for use with wearable computers, which utilizes a display which is separate from the CPU, which can perform as a static flat panel display when connected to or in communication with the computer, but can also function as a thin client PDA when independent from the computer to which it was originally connected. The device will look and function as a flat panel display and include integral activation means either through stylus, touch panel, integrated pointing device, voice, or other activation means. This activation means will be available whether the device is functioning as a display or as a thin client PDA. The device will be small enough to be worn, carried or otherwise supported by the user, but can be utilized independently as a PDA to perform data input, calendars and scheduling, memo inputting and other thin client functions, and will run a thin client operating system such as Windows.RTM. CE or Palm.RTM. OS. The enclosure itself will contain hardware sufficient to support display functions as well as a thin client motherboard. It will also contain either a wired or wireless communication bus for communicating data to the computer from which it was disconnected. Additionally, it will possess a standard or proprietary video input plug for displaying output from the underlying computer.

Clements, U.S. Pat. No. 6,519,565, describes a security method that compares a present verbal utterance with a previously recorded verbal utterance by comparing time-frequency domain representations of the utterances, with multiple repeat utterances forming a basis for determining a variation in repetitious performance by an individual, and similar differences between enrollment and challenge utterances forming a basis for a similar analysis of variance between enrollment and challenge utterances. In one embodiment a set of enrollment data is searched by each challenge until either a match is made, indicating an action, possibly dependent upon the specific match, or no match is made indicating an abort. In one application an individual is accepted or rejected as an imposter, in another application, a selected action is accepted as corresponding to a verbal command.

Cole et al., U.S. Pat. No. 6,152,372, describes a portable computer, which, when activated, a check is made to see if a user has indicated a reduced operating system is to be used. If the user has indicated the reduced operating system is to be use, the reduced operating system is activated. The reduced operating system is stored within a special memory area within the portable computer. The reduced operating system uses less system resources than a full function operating system for the portable computer. If the computer is activated and the user has not indicated the reduced operating system is to be use, the full function operating system of the portable computer is activated.

Hensley, U.S. Pat. No. 0,117,610, describes a modern computer operating system that is altered to boot and run from a protected medium such as a CD-ROM. Files and configuration information are copied from a fully configured and operational OS to a hard drive image file. File system filters and device drivers are added that implement an emulated read-write hard disk drive by servicing initial read requests from the image file, and write requests and read requests to previously written data, from a written disk sector data base. The OS is altered to load the filters and drivers during boot, and to subsequently run from the emulated read-write hard disk drive. The hard drive image file is then placed on a bootable protected medium.

Watanabe et al., U.S. Pat. No. 6,763,458, describes a computer program, and method for multiple operating system support and a fast startup capability in a computer or information appliance. It permits execution of one of a plurality of available operating systems at the time of powering on the device and where data generated within one of the plurality of operating systems is available to a different application program executing within a different operating system on the same device. Provides for unattended file transfers and appliance mode operation for playing back digital audio without the overhead associated with conventional systems. Permit various microprocessor based systems to operate efficiently and with lower overhead. In one aspect, the invention provides a device, such as a computer or information appliance, including a processor and memory coupled to the processor; a storage system coupled to the processor and storing a portion of a first operating system in a first storage region and a portion of a second operating system in a second storage region; the storage system further providing read/write compatible storage and retrieval of data for first and second application programs executing in each of the first operating system and the second operating system respectively; and a boot controller responsive to receipt of a boot control indicator when the processor initiates a boot to an operational state to control booting or the processor into a selected one of the first operating system and the second operating system. Method, computer program, and computer program product are also provided.

Rhoads et al., U.S. Pat. No. 0,158,699, describes a plurality of partitions that may be formed in a non-volatile re-programmable memory, which may act as the primary non-volatile file system for a processor-based system. The memory may store, for example, the basic input/output system for the processor-based system together with its operating system. An address partition may include information about the location of the other partitions, in association with information about the type of information stored in each partition.

Talklam, PCT 09722, describes an operating system that may be stored in a reprogrammable memory. The memory may store a primary operating system and recovery operating system. The recovery operating system may automatically obtain a new operating system to replace a corrupted or outdated operating system. In some embodiments, this avoids the need to call upon the user to load the new operating system through a disk drive and to undertake a time-consuming installation procedure.

Lambert, PCT 67132, describes a single combination data storage device that provides both firmware and disk emulation storage on a single removable media device. Permanent and programmable data of the firmware can be modified on a support computer making the combination device useful for upgrading and initially configuring the firmware for embedded systems as well as their applications, OS kernel, and user data. In a preferred embodiment, the device is implemented with a combination of flash memory for firmware and ATA/flash providing drive emulation in a PC Card or other standard form factor.

Our prior art search with abstracts described above teaches: a method for integrating a removable media disk drive into an operating system recognized as a fixed disk type and modifying an operating system to recognize it as a floppy disk type, a dual FPD and thin client, a method for allowing CD removal when booting an embedded OS from a CD-ROM device, an initializing processor based system from a non-volatile reprogrammable semiconductor memory, a method of altering a computer operating system to boot and run from protected media; a system and method for installing and servicing an operating system in a computer or information appliance, organizing information stored in a non-volatile re-programmable semiconductor memory, re-loading operating systems, and a combination ATA/Linear flash memory device. Thus, the prior art shows that it is known to provide separation of CPU and memory devices as well as CPU and OS. However, the prior art fails to teach the separation of the OS into two parts, one storing the information necessary for boot function and other usage requiring only the memory Read function and not the memory Write function; and the other storing that part of the OS that requires both Read and Write function. The former OS memory is protected by a write control device, a biometric or other protection. The prior art fails to also describe the present invention in terms of its ability to physically and functionally separate OS from CPU/memory. The present invention fulfills these needs and provides further related advantages as described in the following summary.

### SUMMARY OF THE INVENTION

The present invention teaches certain benefits in construction and use which give rise to the objectives described below.

In the best mode preferred embodiment of the present invention, a hardware/software solution is described, that protects an operating system of a computer from being hacked, i.e., accessed by unauthorized users. Hackers typically gain access to a computer by either a malicious piece of code being deposited on the system, i.e., virus, worm, trojan horse, spyware, etc., by, for instance, an authorized user inadvertently or by design; or by one entering the system while it is connected to a network or the Internet, for instance, through one of the system's network ports.

The present invention separates the operating system (OS) into two distinct parts; one for the writable files and the other for the non-writable files. This is accomplished by placing the OS on the two separate storage devices, such as a hard drive, flash drive, flash memory, or a removable storage device. The OS is contained in a separate chassis and is connected to the host computer by a serial bus or any other interconnection scheme. This separate chassis can be physically removed or electrically disconnected if desired.

The storage medium, which has the OS on it, is write protected by using a hardware control device; biometric device, key switch, or other mechanism that controls the write protecting of the storage medium containing the OS. By not allowing users to write to the operating system, the system is protected because no unauthorized code can be placed on it to modify it and its operation.

A novel feature of this invention is that an authentication device places a user's signature file on the OS storage medium and not in the workstation's storage device. This prevents hackers from spoofing (copying) the user's identification code from the workstation and gaining access to the data files and the network. Current authentication methods places user information on the local hard drive in the form of files which are accessible to hackers either through the network of any other data input means.

In typical systems, additional security is achieved by using software encryption schemes employed by operating systems such as Microsoft, IBM, Sun, Unix, and Linux. In the case of Microsoft, the data files are encrypted and can only be read by means of Microsoft's file encryption process. Microsoft's encryption procedure marries the operating system with the files so that if a file is copied from a specific computer with its specifically assigned OS, the files can not be placed on another computer and read because the encryption scheme works only on the original computer. The present invention is to remove the OS from the files so that no one can read the files unless they have the original OS for that computer.

The data files are protected through the use of Microsoft's encryption program and can not be viewed by hackers from the outside world. Most computer users do not know that Microsoft includes an encryption program that can be turned on for each specific computer's OS so as to prevent any other same OS from viewing or using the files. The network ports are protected by user permission levels that can only be set by the OS re-writing its own selected files.

A primary objective of the present invention is to provide an apparatus and method of use of such apparatus that yields advantages not taught by the prior art.

Another objective of the invention is to prevent unauthorized use of a computer system.

A further objective of the invention is to prevent unauthorized entry to an operating system of the computer system.

A further objective of the invention is to store portions of the operating system on two separate memory devices, one being read and write selectable, while the other of the memory device is read/write.

A still further objective of the invention is to separate the operating system and the memory and central processor unit of the computer so that it is possible to physically remove one from the other to insure against unauthorized use.

Other features and advantages of the embodiments of the present invention will become apparent from the following more detailed description, taken in conjunction with the accompanying drawings, which illustrate, by way of example, the principles of at least one of the possible embodiments of the invention.

### BRIEF DESCRIPTION OF THE DRAWINGS

The accompanying drawings illustrate a best mode embodiment of the present invention. In such drawings:

FIG. 1 is a block diagram of the invention showing its interconnection scheme; and

FIG. 2 is a block diagram of a specific preferred embodiment of an operating system module of the invention.

### DETAILED DESCRIPTION OF THE INVENTION

The above described drawing figures illustrate the present invention in at least one of its preferred, best mode embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

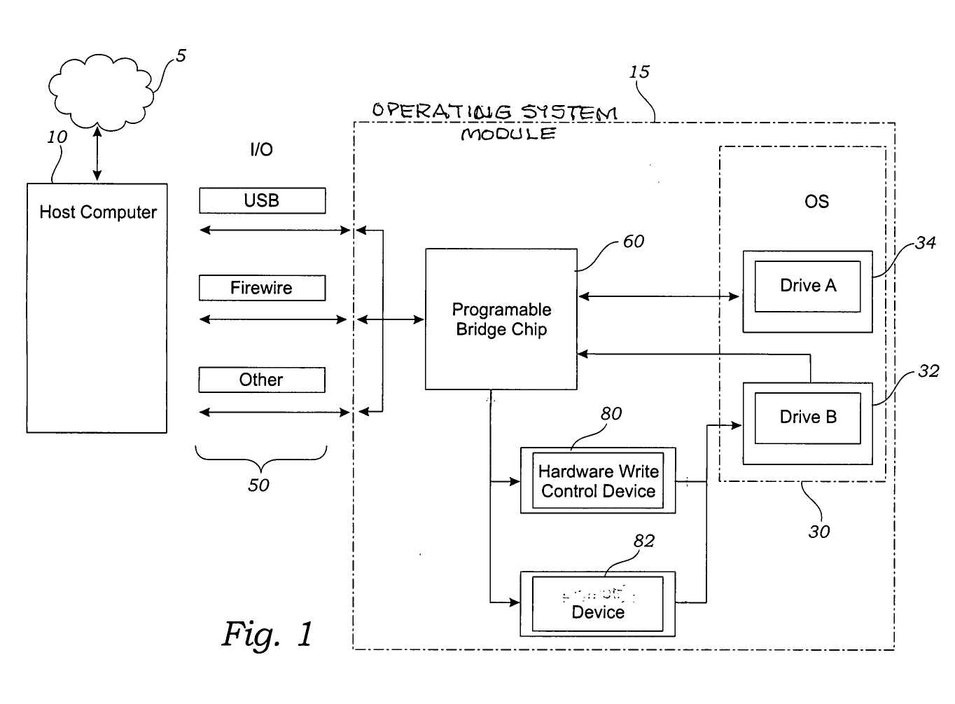

In the preferred embodiment of the present invention, as shown in FIG. 1, a host computer 10, being any data processing system, comprises enablement for communicating with (i) a data signal network 5, such as the Internet or other wide area data signal network, or an intranet; and (ii) an OS module 15, which shall be defined herein. Such enablement may be via any one or more well known connection system or I/O device 50 such as a USB port or alternative devices. The OS module 15 comprises components including: a data signal gate 60, a hardwire write control device 80, a first memory device 32, and a second memory device 34. The memory devices 32 and 34, jointly store an operating system (OS) 30 functionally necessary for operating the host computer 10, i.e., computer 10 is unable to receive or process information without being in signal communication with the OS 30. The first and second memory devices 32 and 34 together provide the entire OS 30 necessary for operation of host computer 10. Devices 32 and 34 are each preferably a solid state memory, also referred to as a flash memory, or they may be a hard drive, a removable disk drive or any other memory device of sufficient size and with sufficient access speed to fulfill the function of a modern computer operating system. The two memory devices 32 and 34 need not be of the same type. The first memory device 32 holds only those portions of the OS 30 that are unchanged during startup (booting) and operation of the host computer 10, such as the addresses of the many registers in the host computer 10 and the I/O port addresses; while the second memory device 34 holds those further portions of the OS 30 that are subject to change during startup and operation of the computer, such as date and time information, current size and use of registers and the segmentation and allocation of hard drives, and the status of all other components in the host computer 10 as well as the OS module 15.

The aforementioned components are interconnected for data signal flow between the host computer 10 and the second memory device 34, referred to as “Drive A” in FIG. 1. It is shown by the arrows in FIG. 1 that data may freely flow bilaterally between host computer 10 and memory device 34.

FIG. 1 also shows that signal flow between the host computer 10 and the first memory device 32 is constrained. For instance, data flow from memory device 32 moves to host computer 10 through data signal gate 60, but data flow from computer 10 moves to the first memory device 32 only through one of the write control device 80 or through a biometric gate device 82. In this manner, first memory device 32 is fully protected from data that could corrupt it.

Preferably, the data signal gate 60 is a programmable bridge chip.

As mentioned, the computer enablement for communicating with the OS module is preferably a USB port, or it may be a Firewire® port, a parallel port and a serial port.

Preferably, the biometric gate device 82 includes at least one of: a finger print reader, an iris reader, and a voice recognition system, however, it may include any other biometric device that fulfills the need for security in the operation of the host computer 10 and the memory devices 32 and 34.

Preferably, the OS module 15 is either physically separable or functionally separable from the host computer 10. As shown in FIG. 1, the I/O device 50 is enabled for the OS module 15 to be physically unplugged and removed from the site of the host computer 15.

Alternately, functional separation is enabled by disconnection of data signal paths within the bridge chip.

Preferably, the write control device 80 is a physical switch which, when opened, prevents signal flow through device 80 to the second memory device 32. The write control device 80 may also be a security card reader, a number pad for entry of a PIN, an RF ID reader for reading a RF ID coded device, or any other security device that a reader or sensor can detect.

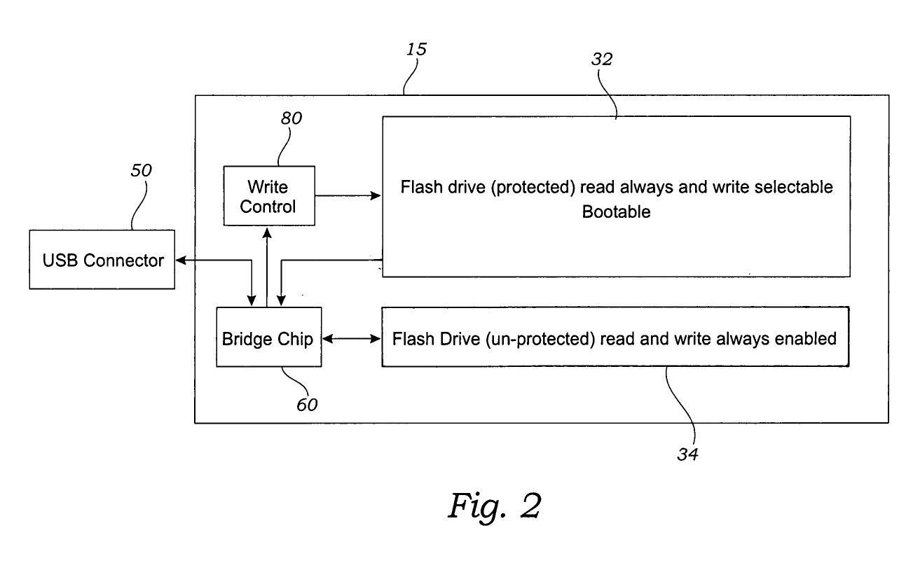

As shown in FIG. 2, a preferred embodiment of the OS module of the present invention includes the use of USB connector 50 for making signal interconnection with host computer 10, and flash drive memory devices for the first memory device 32 and the second memory device 34. This configuration of OS module 15 is highly compact and fulfills the function of being able to be disconnected and reconnected to a typical modern host computer 10 through its USB port.

The method for placing a computer operating system onto the first and second drives referred to above includes the following steps:
1. start computer
2. press del key while booting, this opens up bios screen where user makes changes
3. select boot option screen or advanced settings
4. select 1^{st} boot device to be USB HDD
5. connect OS module to the computer
6. enable the first drive for writing data thereto and copy all files in root directory/winnt from the c: drive of the computer to the first drive of the OS module
7. write protect the first drive of OS module
8. reboot the computer
9. computer displays input command box asking where to save user input data, change setting in command box from drive c: to the second drive of the OS module
10. computer system restarts and command box is displayed requiring user input (input/output, display, hardware configuration, user identification, password, etc)
11. as each command box is displayed user makes choices (users inputs settings)
12. computer displays command box requesting drive to save settings. Save.
13. continue until all required user input is completed.
14. reboot the computer

The enablements described in detail above are considered novel over the prior art of record and are considered critical to the operation of at least one aspect of one best mode embodiment of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of the embodiments of the herein described invention and its related embodiments not described are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A data processing system comprising: a computer enabled for communicating with (i) a data signal network and (ii) an OS module; the OS module comprising components including: a data signal gate, a hardwire write control device, a first memory device, and a second memory device; the first memory device holding portions of an OS that are unchanged during startup and operation of the computer; the second memory device holding portions of the OS that may be changed during startup and operation of the computer; the components interconnected for data signal flow between the computer and the second memory device through the data signal gate, and further interconnected for data signal flow between the computer and the first memory device through the data signal gate and the write control device.

2. The system of claim 1 wherein the data signal gate is a programmable bridge chip.

3. The system of claim 1 wherein the computer enablement for communicating with the OS module is at least one of a USB port, a Firewire® port, a parallel port and a serial port.

4. The system of claim 1 wherein the components further include a authentication device established in parallel signal flow with the write control device.

5. The system of claim 4 wherein the authentication device is at least one of: a biometric gate, a physical switch, a wave energy sensing device, a magnetic device.

6. The system of claim 1 wherein the OS module is at least one of: physically separable and functionally separable from the computer.

7. The system of claim 1 wherein the functionally separable enablement includes disconnection by data signal paths within the bridge chip.

8. The system of claim 1 wherein the write control device is a physical switch.

9. The system of claim 1 wherein at least one user signature is stored in the first memory device.

10. An OS module enabled for interconnection with a computer and removable therefrom, the OS module comprising components including: a data signal gate, a write control device, a first memory device, and a second memory device; the first memory device holding portions of an OS that are unchanged during startup and operation of the computer; the second memory device holding portions of the OS that may be changed during startup and operation of the computer; the components interconnected for data signal flow between the computer and the second memory device through the data signal gate, and further interconnected for data signal flow between the computer and the first memory device through the data signal gate and the write control device.

11. The system of claim 10 wherein the data signal gate is a programmable bridge chip.

12. The system of claim 10 wherein the components further include a authentication device established in parallel signal flow with the write control device.

13. The system of claim 12 wherein the authentication device is at least one of: a biometric gate, a physical switch, a wave energy sensing device, a magnetic device.

14. The system of claim 10 wherein at least one user signature is stored in the first memory device.

15. A computer system including an OS module enabled for insertion into, and removal from operating circuits of the computer system, the OS module comprising components including: a data signal gate, a write control device, a first memory device, and a second memory device; the first memory device holding portions of an OS that are unchanged during startup and operation of the computer; the second memory device holding portions of the OS that may be changed during startup and operation of the computer; the components interconnected for data signal flow between the computer and the second memory device through the data signal gate, and further interconnected for data signal flow between the computer and the first memory device through the data signal gate and the write control device.

16. A computer system including an OS module engaged with operating circuits of the computer system, the OS module comprising components including: a data signal gate, a write control device, a first memory device in the operating circuits, and a second memory device not in the operating circuits; the first memory device holding portions of an OS that are unchanged during startup and operation of the computer; the second memory device holding portions of the OS that may be changed during startup and operation of the computer; the components interconnected for data signal flow between the computer and the second memory device through the data signal gate, and further interconnected for data signal flow between the computer and the first memory device through the data signal gate and the write control device.

17. The computer system of claim 1 further providing authentication files in the first memory device.

18. The OS module of claim 10 further providing authentication files in the first memory device.

19. The OS module of claim 15 further providing authentication files in the first memory device.

20. The OS module of claim 16 further providing authentication files in the first memory device.

21. A method of separating an OS of a computer into a portion that remains unchanged in a first drive memory during startup and operation of the computer, and a portion that may be changed in a second drive memory during startup and operation of the computer; the method comprising the steps of:
a) open the bios screen presenting user options;
b) write the entire OS of the computer to the first drive memory;
c) write protect the first drive memory;
d) write only a user changeable portion of the OS from the first drive memory to the second drive memory.

22. An OS of a computer comprising: a first memory device, and a second memory device; the first memory device holding portions of the OS that are unchanged during startup and operation of a computer; the second memory device holding portions of the OS that may be changed during startup and operation of the computer.

23. The OS of claim 22 wherein the first and second memory devices are one of: a single removable disk memory, a pair of removable disk memories, a single solid state memory, and a pair of solid state memories.

24. The apparatus of claim 1, further comprising a memory device containing instructions for bifurcating the OS into relevant parts.

25. The apparatus of claim 24 wherein the instructions are a software instruction set for automatically or semi-automatically bifurcating the OS.
